(19) United States
(12) Patent Application Publication
(10) Pub. No.: US 2005/0023823 A1
(43) Pub. Date: Feb. 3, 2005

(54) Novelty business card

(76) Inventor: Kevin Kawasaki, Belmont, CA (US)

Correspondence Address: MORRISON & FOERSTER LLP, 755 PAGE MILL RD, PALO ALTO, CA, 94304-1018, US

(21) Appl. No.: 10/884,332

(22) Filed: Jul. 1, 2004

Related U.S. Application Data
(63) Continuation of application No. PCT/US04/07811, filed on Mar. 12, 2004.
(63) Continuation-in-part of application No. 10/388,551, filed on Mar. 13, 2003.

(51) Int. Cl. B42D 15/00

(52) U.S. Cl. 283/117

(57) ABSTRACT

A device with one or more edges configured for facilitating the removal of debris from surfaces. In one variation, the device comprises a card-shaped body with a squeegee edge and a pocket for receiving a business card. The user may insert his business card into the device to customize the card device into a marketing medium. The device may be configured to be about the size of a business card and having a widow or slit for holding a business card. Lettering, logos, or other messages may be printed on the front and/or back surfaces of the card to provide additional information. The device may have a squeegee, a scraping edge, and/or a brush attached to its edges. The scraping device with a business card pocket may serve the dual purpose as an information distribution medium and as a compact debris removal device.

### CROSS-REFERENCE TO RELATED APPLICATION

This is a continuation of PCT Application No. PCT/US2004/007811, having an International Filing Date of Mar. 12, 2004, and a continuation-in-part of pending U.S. patent application Ser. No. 10/388,551, filed Mar. 13, 2003.

### FIELD OF THE INVENTION

The present invention relates to a compact device for wiping, spreading or pushing materials from a relatively smooth surface. The inventive device is designed to facilitate removal of various debris, e.g. dirt, snow, dew and water, from a smooth surface such as a car windshield and at the same time serve as an information distribution medium for marketing purposes. Specifically, the device may be configured with a pocket for receiving a business card.

### BACKGROUND OF THE INVENTION

It is common for automobile operators to discover bird droppings, dirt, dried insets and other debris on the windshield or other surfaces of their cars. In many instances, such debris had been attached to the car surface for an extended period of times and had solidified or bonded to the surfaces of the car. Car washing and regular wiping often fails to remove these hardened debris.

Various devices have been devised for cleaning the windshield of a car. However, much of the prior work focused on removing snow and ice from the windshield. In addition, these devices tend to be large and bulky. Examples of such devices are disclosed in U.S. Pat. No. 2,277,528, issued Mar. 24, 1942 to Osborn; U.S. Pat. No. 3,229,316, issued Jan. 18, 1966 to Matheson; U.S. Pat. No. 5,709,005, issued Jan. 20, 1998 to Brach, Jr. et al.; U.S. Pat. No. 5,857,237, issued Jan. 12, 1999 to Dranginis; U.S. Pat. No. 5,009,540, issued Mar. 31, 1992 to Paschetto; U.S. Pat. No. Des. 320,483, issued Oct. 1, 1991 to Desautel; U.S. Pat. No. Des. 349,592, issued Aug. 9, 1994 to Stoll; and U.S. Pat. No. Des. 426,757, issued Jun. 20, 2000 to McGrellis; each of which is incorporated herein by reference in its entirety.

A compact and easily carried device for removing debris or liquid condensations from windshields and outer surfaces of the car is much desired. Preferably, the device may be utilized for removal of hardened debris as well as soft or liquid materials, such as dew, from the metallic surfaces of the car without causing significant damage. Furthermore, such device may also carry logos and/or other messages so that it may serve as a marketing medium. For example, devices such as these may be handed out at car washes, gas stations, auto dealers, and trade shows for promotional purposes. In another example, real-estate agents may insert their own business cards inside the devices and hand them out to prospective clients. Thus, a dual-purpose marketing and debris removal device that is compact and easy to handle may be desirable.

### SUMMARY OF THE INVENTION

The present invention includes a card-shaped device for removal of debris (e.g. dirt, bird droppings, snow, ice, water, etc.) from the outer surface of a car. The present invention may provide a pliable edge on the card shaped device for removing debris without inflicting damages to the underlying surface. The card may include a pocket for receiving a standard business card. The card may further include logos, markings or other messages on its outer surface for information distribution purposes.

The device may be designed to serve as and be shaped like a business card. Alternatively, the device may be slightly larger or smaller, but maintains the general width and length proportion so that it may be easily identified as a business card. The device may be thicker than a traditional business card such that sufficient strength and/or durability may be achieved. Alternatively, it may be the size of a credit card or it may be squared shaped.

Generally the device is relatively thin and compact such that it may be easily handled and transferred with human hands. The compact design may also allow easy storage. For example, it may be configured such that it can easily fit into a purse, a wallet, a glove compartment, or a coin/ash tray in a car.

The novelty business card may have one or more flexible and/or compliant edges for facilitating removal of liquid or residue from a surface. In one aspect of the design, “squeegee” materials are provided on one or more of the four edges of the card device. For example a blade of rubber or polymeric material attached to one of the four edges on the card may be used for spreading, pushing or wiping materials across or off a relatively smooth surface. The device may further comprise a scraping edge in addition to the squeegee edge. The scraping edge may allow the user to remove materials that have solidified or hardened. In another variation, a brush may be adapted to one of the edges on the device. For example, the card device may have a squeegee edge at one end and a brush edge on the other. Alternatively, the card device may also have a squeegee edge, a scraping edge and a brush edge, or any combination thereof.

The squeegee feature may be particularly useful for removing debris from the metallic surfaces of the car since scraping of metallic surface with a hard edge may leave scratches and other marks. In addition, cloth, sponge or other soft materials may not allow the user to exert enough pressure to remove the debris that had attached or stuck to the surface of the car. The scraping edge may be useful for removing bird droppings, and other debris that have attached to the windshield and other window surfaces. The brushing edge may allow the user to dust small areas or openings both inside and outside the card. For example, vents and real view mirrors may have dust particles buildup that needs to be removed.

Advertising indicia (e.g., logos, markings, messages, name, address, telephone number, etc.) and/or other information may be printed or formed on the surface of the card devices so they may be distributed to the public for promotional or other marketing purposes. In particular, the device may include printed material on one side, of the same configuration and spacing found on a normal business card, e.g., name and title in the center and company, address, phone number, email address, etc. in a corner. The reverse side may have the same information in another language.

In one variation, low cost materials and processes may be used for mass production of the device. The resulting low cost product may be useful for mass distribution or for disposable applications. Car washes, gas stations, and car dealers may distribute these devices to customers or potential customers for marketing purposes. The customer may use these devices to remove bird droppings, other animal defecate, bugs and other debris from the windshield, head lights or other surfaces on a car.

In another variation, the novelty business card may have a pocket to receive a typical business card (e.g., for example, a plastic pocket for holding a typical paper business card). In another example, the novelty business card comprises a scraper about the size of a typical business card and further configured with a slot or window for receiving a typical business card. The generic scraper and/or squeegee business card device may be customized by individual by inserting their own business card into a built-in slot or holder. In another variation, the generic scraper and/or squeegee business card device has corporate information or other marketing information printed on its surface, and an individual may insert his own business card or a of paper or plastic card with his own name and/or contact information on it to customize the generic scraper/squeegee business card device.

These and other embodiments, features and advantages of the present invention will become more apparent to those skilled in the art when taken with reference to the following more detailed description of the invention in conjunction with the accompanying drawings.

### BRIEF DESCRIPTION OF THE DRAWING

In the accompanying drawings, reference characters refer to the same parts throughout the different views. The drawings are intended for illustrating some of the principles of the novelty business card device and are not intended to limit the invention in any way. The drawings are not necessarily to scale, emphasis instead being placed upon illustrating the depicted principles in a clear manner.

FIG. 1 illustrates one variation of a novelty business card having a squeegee attached on one edge of the card and an opposite edged is configured for scrapping purposes.

FIG. 2 is a cross-sectional view of another variation of a novelty business card where the scrapping edge is a separate part that is attached to the body of the card.

FIG. 3A is yet another variation of a novelty business card. In this variation a squeegee material completely surrounds the peripheries of the card.

FIG. 3B is the side view of the novelty business card shown in FIG. 3A.

FIG. 4A illustrates one variation of a squeegee connected to the body of a card device. In this variation, the squeegee has a triangular shaped surfaces and a rod shaped extension for interlocking with the body of the card.

FIG. 4B illustrates another variation of a squeegee connected to the body of a card device with adhesives. In this variation, the squeegee gradually thin-out as it extends away from the card.

FIG. 4C illustrates yet another variation of a squeegee connected to the body of a card device. In this variation, the squeegee has a rod-like extension with linear groves on the surface of the rod. In addition, a rectangular shaped extension is provided for interlocking with the card.

FIG. 4D illustrates yet another variation of the squeegee connected to the body of a card device. In this variation the surface of the squeegee are jagged and uneven. In addition a rod shaped extension is provided for interlocking with the body of the card.

FIG. 4E illustrates yet another variation of the squeegee attached to the body of a card device. In this variation the squeegee comprises of two blade extensions.

FIG. 4F illustrates yet another variation of the squeegee attached to the body of the card device. In this variation, the squeegee has a partially circular cross-section with groves on the surface of the squeegee.

FIG. 5A shows one variation of a scraping edge with slanted surface and indentations.

FIG. 5B shows another variation of a scraping edge with multiple tooth-like extensions.

FIG. 6 shows another variation of a card device where a squeegee is attached to the lower edge of the card and the upper edge of the card is double beveled.

FIG. 7 shows another variation of a card device having two scraping edge and one squeegee edge. The left edge is configured as a scraping edge with saw like extensions. The upper edge is also configured as a scraping edge with a slanted surface. The bottom edge has a squeegee attached along the width of the edge surfaces.

FIG. 8 shows one variation of a squared shaped card having a squeegee attached to the top edge and the bottom edge configured as a scraping edge.

FIG. 9 is a perspective view of another variation of a novelty business card having a top edge with a brush extension and a bottom edge with a squeegee extension.

FIG. 10 is a perspective view of yet another variation of a novelty business card having a right edge with a brush extension, a bottom edge with a squeegee extension and a top edge with a beveled scraping surface. A bottle opener is further incorporated into the novelty business card. An optional key ring hole is also shown in the lower left corner of the device.

FIG. 11 shows another variation of a novelty business card having a clear plastic pocket attached to one surface of the device for receiving a typical paper-based business card.

FIG. 12 shows another variation of a novelty business card wherein a slot is provided within the body of the device for receiving a typical business card.

FIG. 13 shows another variation of a novelty business card configured with a clear window for receiving a strip of paper or plastic. Optional characters, numbers or logs may be printed on the surface of the device as shown.

FIG. 14A illustrates another variation where the body of the novelty business card device comprises a clear or semi clear plastic, and a slot is provided within the body of the device to receive a paper or plastic card. In the example shown here, a business card may be inserted into the body. Once the business card is inserted inside the device lettering on the business card will be visible through the body of the device.

FIG. 14B shows the card device of FIG. 14A with a typical business card inserted in the body of the card device.

FIG. 15A illustrates another variation where the card device has a built-in compartment for storing objects.

FIG. 15B shows the card device of FIG. 15A being flipped over with the card device under-side showing.

FIG. 16A illustrates another variation where the card device comprises a compartment with a flip-cover and a separate slot/compartment for receiving a business card.

FIG. 16B shows the card device of FIG. 16A with its flip-cover in the opened position.

FIG. 17A shows a variation of a card body with an attachment mechanism for receiving an accessory. Three accessory variations, a squeegee, a brush, and a comb, are also shown.

FIG. 17B illustrates another variation of a card device where the card device comprises a comb edge. A business card is inserted inside the card device.

### DESCRIPTION OF THE INVENTION

Before describing the present invention, it is to be understood that unless otherwise indicated cleaning of car surfaces is used herein as an example application to illustrate the functionality of the different aspects of the invention disclosed herein. It will be understood that embodiments of the present invention may be applied in a variety of cleaning and debris clearing applications and are not limited to cleaning the surfaces on a car. Furthermore, the term “squeegee” means one or more pieces of pliable and/or flexible material used for spreading, pushing, or wiping liquid material on, across, or off a surface.

It will also be understood that embodiments of the present invention may be applied in combination with various cleaning devices and processes, and it is not limited to the specific examples describe herein.

It must also be noted that, as used in this specification and the appended claims, the singular forms “a,” “an” and “the” include plural referents unless the context clearly dictates otherwise. Thus, for example, the term “a scraping edge” is intended to mean a single scraping edge or a plurality of scraping edges, “a squeegee” is intended to mean one or more squeegee, or a combination there of.

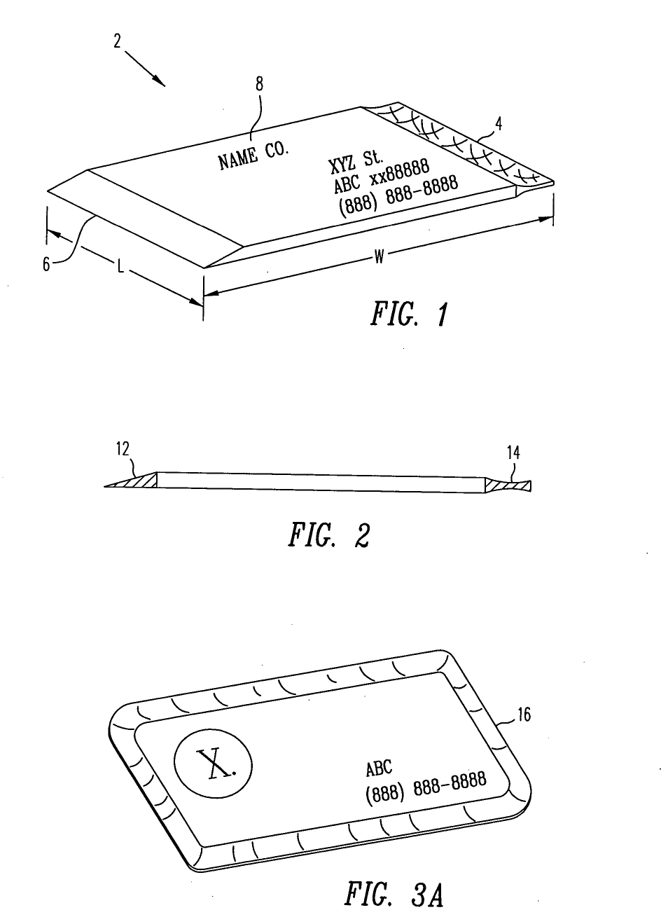

One variation provides a card shaped device with at least one edge of the card having a squeegee material. Preferably, the device is compact such that it may be easily handled and distributed by human hands. It is even more preferable that the device may fit in the palm of an average adult in the United States. In one variation, the device 2 is about the size of a business card. A squeegee 4 may be attached to one edge of the card as seen in FIG. 1. Another edge 6 of the card may be configured with a shape adapted for scraping. Lettering, logos, messages and/or markings may be provided on the front surfaces 8 of the card. Optionally, the back surface of the card may also have messages and/or markings. The card may be thicker than the usual business card to provide appropriate stiffness.

In another variation, the device is the size of a business card commonly used in the United States, having a width (“W” in FIG. 1) of about 3.5 inches and a length (“L” in FIG. 1) of about 2 inches. Alternatively, the device may be the size of a business card commonly used in Asia, having a width of about 9 centimeters and a length of about 5.4 centimeters. In another variation, the device is about the size of a credit card, having a width of about 3 and ⅜ inches and a length of about 2 and ⅛ inches. In yet another variation, the device is about the size of a standard playing card, having a width of about 2 and ¼ inches and a length of about 3 and ½ inches. The device may also be squared shape. In one variation, the device is about 3 inches by about 3 inches. In another variation, the device is about 2 and ½ inches by about 2 and ½ inches. In yet another variation, the device is about 2 inches by about 2 inches. The devices may be various rectangular shapes, but generally it is preferable that the width and length are each equal or less than 4 inches. It is more preferable, the width and length are each equal or less than 3 and ½ inches.

The corners of the card shaped device may be squared (an example is shown in FIG. 1), or may be rounded (an example is shown in FIG. 3A). All four corners of the card may be squared or they may all be rounded. Alternatively, two corners are rounded and two corners are squared. It may also be possible that only one of the corners is rounded or squared. In an alternative design, one or more of the corners may be indented or absent. Even if one or more of the corners are missing, it is preferable that the device maintains a general shape of a card.

The height of the device may be greater than the thickness of a business car or credit card. The greater thickness provides increased strength and durability in the device so that appropriate pressure may be applied with the device for scraping and/or wiping. Preferably the height of the device is less than 1 centimeter. More preferably, the height of the device is less than 0.8 centimeter. Even more preferably, the height of the device is less than 0.5 centimeter. Further more preferably the height of the device is less than 0.3 centimeter. And most preferably, the device less than 0.2 centimeter.

As discuss earlier, one of the edges of the card shaped device may have a squeegee surface. However, more than one of the edges may also have squeegee surfaces. In one variation, two of the edges have squeegee surfaces. The two edges with squeegee surfaces may be opposite each other or may be adjacent to each other. For example, FIG. 2 illustrates a card with two separate squeegee edges 12, 14. In this example, the two squeegees 12, 14 have different shapes. In another variation, three of the edges have squeegee surfaces. In yet another variation, all four edges have squeegee surfaces 16, as seen in FIG. 3A. FIG. 3B illustrates a side few of this particular design.

The squeegee materials attached to the edge of the business card for forming the squeegee surfaces may comprised of various pliable and/or flexible materials that are well known to one skill in the art for constructing squeegees. For example, the squeegee may comprise of natural rubber, synthetic rubber, foam rubber, silicone, neoprene, polyurethane, thermoplastic, flexible plastic materials, thermoplastic elastomer, a combination of various thermoplastic, or a combination of one or more of the polymers described above. The squeegee may also be made by combining plyurethane/urethane elastomers with dense polyester fill.

The body of the card device may comprise of metal, metal alloys, plastic, or polymers such as polystyrene, acrylic, PVC, ABS, polycarbonate or other hard polymeric materials that are well known to one skilled in the art. When large quantities are desired, the device may be made by extrusion or by injection molding. Alternatively, the device may be fabricated through lamination of two or more polymer sheets. A squeegee may be attached to the edge of the sheet by trapping parts of the squeegee body between the two sheets.

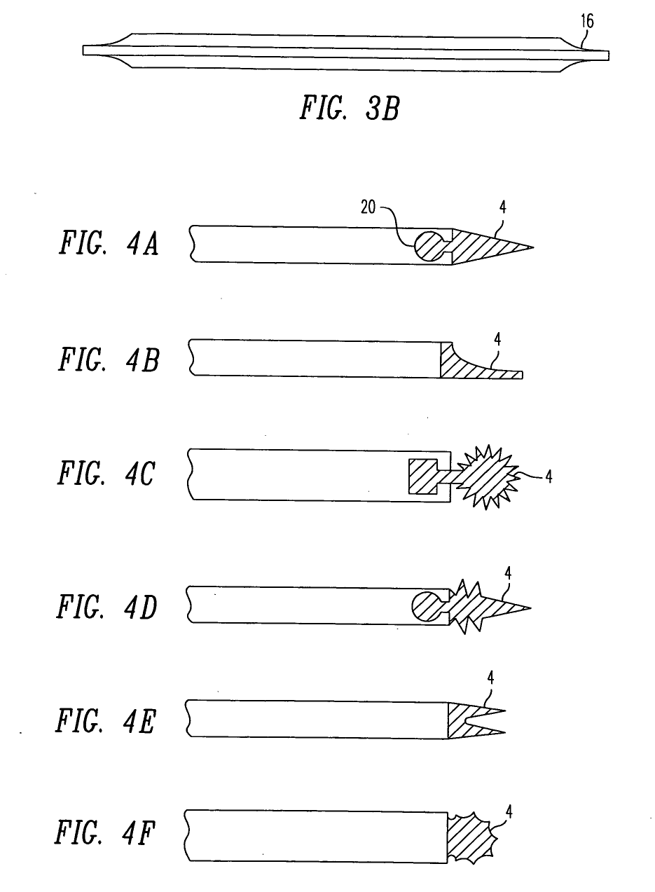

The squeegee may be attached to the body of the card with various adhesive or bonding materials (e.g., acrylic, cyanoacrylate/methacrylate, epoxy, heat activated adhesives, hot melt adhesives, hydrocolloid/hydrogel, moisture-cure adhesives, polyester, silicone, urethane, UV or light-cure adhesives, etc.) that are well known to one skilled in the art. Alternatively, a groove or duct or slot may be provided for securing the squeegee. The squeegee may have corresponding features that fit into the groove or duct to enhance locking between the two parts. For example, at one edge of the card there may be a circular duct 20, as show in FIG. 4A. A squeegee 4 with a matching rod-like surface may be slid through the duct and thus attached to the body of the card. Adhesive or other bonding materials may also be used with the duct or groove to enhance the strength of the attachment. Although it is preferable that the squeegee be attached to a longitudinal edge of the card body, the squeegee may also be attached to the upper and/or lower edges of the card body.

In another variation, the device is formed of a single piece of a polymeric material. The device may be molded into the desirable shape through plastic injection molding or formed into a multi-polymer sheet by extrusion and later cut into appropriate length sections. Variations in temperature treatment, chemical treatment, doping or other methods well known to one skilled the art may be implemented to change the flexibility of the material at different sections of the device. The squeegee edge of the device is preferably softer and more flexible than the body. The flexible end may also be shaped or molded to provide good squeegee actions. Optionally, at the second edge where the material is hard, the edge may be formed or shaped to provide good scraping action. The device formed of the same piece of material as described above may have particularly low cost of production.

The surface of the squeegee may have various shapes and/or patterns to enhance its ability to remove debris from surfaces. Examples of some of the possible configurations of the squeegee are shown in FIG. 4A-4F. One or more squeegee blades or materials may also be attached to a signal edge.

In another variation, in addition to the squeegee edge, one or more scraping edge may be provided. The scraping edge may be molded on to the edge of the device during the manufacturing process. Alternatively, the scraping edge may be shaped or cut out of the body of the card. It may also be possible to attach a scraping edge to one of the edges on the body of the card. The scraping edge may comprise of metal, metal alloys, polystyrene, Acrylic, PVC, ABS, polycarbonate or other hard polymeric materials that are well known to one skilled in the art.

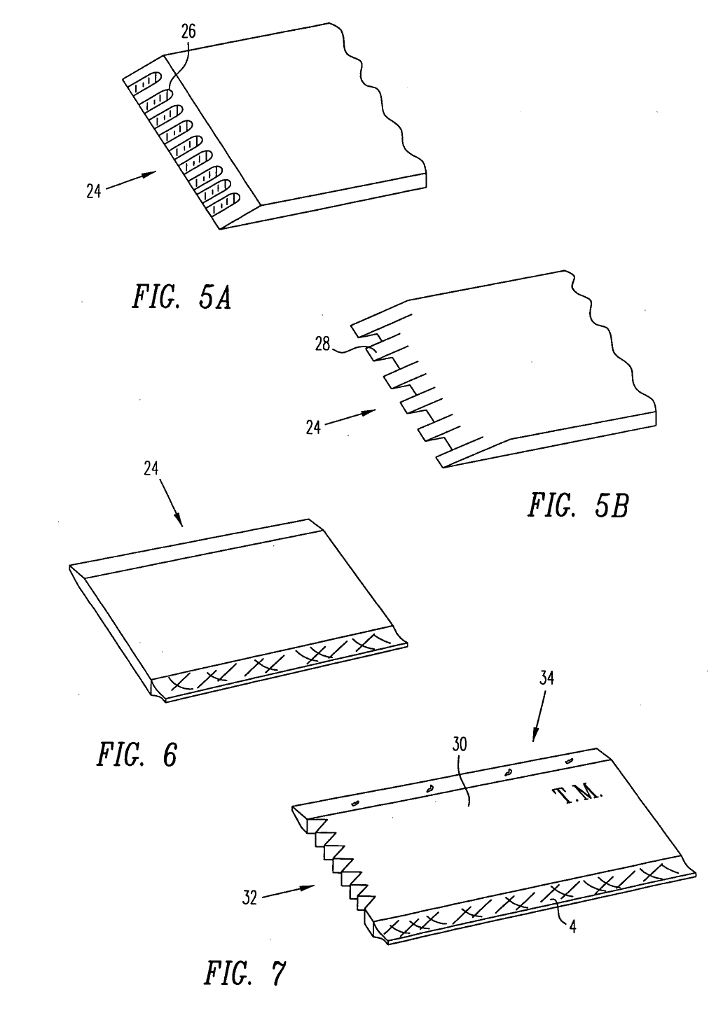

The scraping edge may have various shapes or features to enhance the scraping action. For examples, the scraping edge 24 may have indentations 26 or teeth 28 as shown in FIGS. 5A and 5B. In another variation, the scarping edge is serrated. Alternatively, the scraping edge 24 may comprise of a slanted surface without any special features or patterns, as shown in FIG. 6. For example, the scrapping edge 24 may be beveled or double beveled. In another design variation, as showing FIG. 7, the device comprises a card body 30 with a squeegee 4 attach along one of the edges. The squeegee is comprised of polyurethane. The card body is molded with polyvinyl chloride. A tooth shaped scraping edge 32 and a separate smooth and inclined scraping edge 34 are molded on to the card body 30. The complete device, including the card body 30 and the squeegee edge 4, has a dimension of 3.5 inch×2 inch×0.125 inches, with rounded corners.

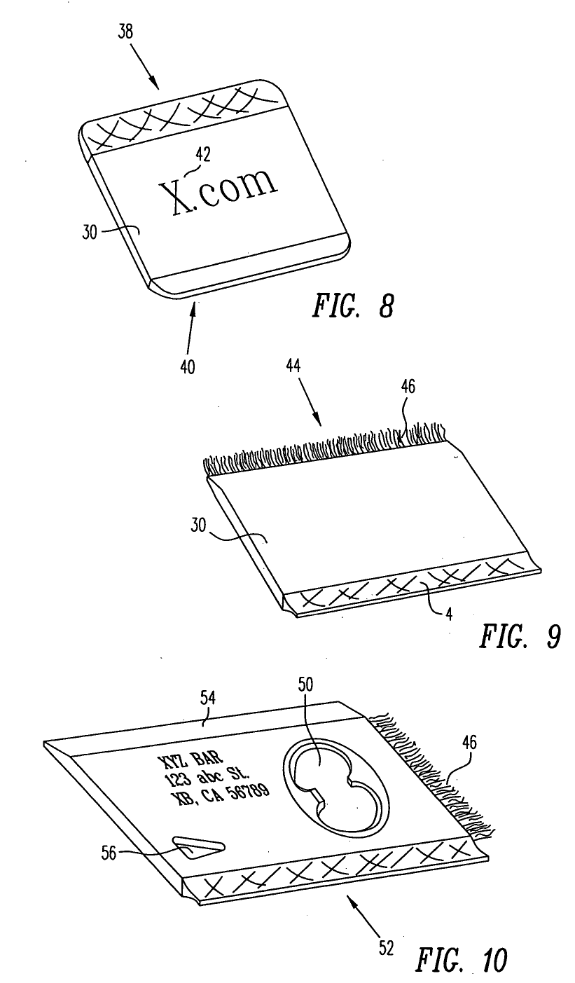

An example of a square shaped card is shown in FIG. 8. In this example, the body 30 of the card comprises a continuous piece of polymeric material. At one edge 38, the materials have been softened and the edge is shaped to provide good squeegee action. At the opposite edge 40, the material maintains its original rigid characteristic and it is shaped to provide good scrapping action. A logo is molded onto both the front and backside of the card. In this particular example, the card has a dimension of 2.5 inch×2.5 inch.

In another aspect of the invention, a brush is provided at one or more edges of the card. The brush may comprise of natural or synthetic materials that are well known to one skilled in the art to provide sweeping action. Alternatively, the brush is comprised of synthetic polymeric fibers. The brushing edge may be implemented on the card by itself or in combination with scraping edge or brushing edge or both. FIG. 9 illustrates one variation of the device having a brushing edge 44. A brush is attached along the top edge of the card body, and a squeegee 4 is attached to the bottom edge of the card body 30. In this variation, the card body 30 may be about the size of a standard business card and the brush 46 and the squeegee 4 extend slightly beyond the boundary defined by a standard business card. In another variation, the complete device, including the brush 46 and squeegee 4 is about the size of a business card.

In yet another variation of the novelty business card, an opening is provided on the business card. The opening 50 may be configured such that the card may serve as a bottle opener, as seen in FIG. 10. In this variation the device has a squeegee edge 52 along one of the longer edges, which may be used to remove fluids from counter tops. The novelty card may also have a hard scraping surface 54, which may be used to remove gums or other materials that have stuck onto the counter tops. In addition, the novelty card may also have a brush 46 at another edge for sweeping dust or other particles. A key ring hole 56 may also be provided on the novelty business card if desired.

In anther variation, a magnetic material is attached or integrated into the card device, such that the user may place the card device on a metallic surface. For example, the user may place the card device on a refrigerator door or on a metal bar or surface inside the car, and the card device would stay in placed due to the magnetic force. In another example, a thin layer or magnetic sheet (e.g., 0.04 millimeter) is glued to the under side of the card device. This may allow the user to place the card device on a metallic surface such as on a refrigerator door.

In general, metal, metal alloys or other materials with appropriate strength may be incorporated into the card device for strengthening of the device structure. In particular, strengthening materials may be incorporated during the device fabrication process to provide appropriate structure support for the bottle opener feature embedded in the card device.

In another aspect of the invention, advertising indicia such as lettering, makers, logs, boarders, advertising messages and the like may be impressed on or formed on the front and/or back surfaces of the novelty cards. Since the surface of the card may be substantially planner, an image may be imprinted conveniently thereon. In one possible approach, the image and or message may be imprinted onto the device using printing methods commonly employed in imprinting credit cards, e.g., embossing. Alternatively, dye sublimation techniques may be employed to heat transfer the desired image or messages onto the body of the card. Silk-screening techniques, offset printing, ultraviolet methods, and other methods commonly used in printing marks and letters on plastics that are well know to one skilled in the art may also be used. Alternatively, the lettering and logos may be indented or protruding form the card surface. The indented or protruding features may be formed through carving, etching, molding, or otherwise formed with manufacturing processes well known to one skilled in the art. The lettering, logos and other marks may also be molded onto the surface of the card during the manufacturing of the card body.

In one variation, a firm name, an address, a phone number, an email address and a logo are printed on the novelty business card. In another variation, a corporate logo along with an Internet address is printed on the card. One or both side of the card may have lettering or marks printed on them.

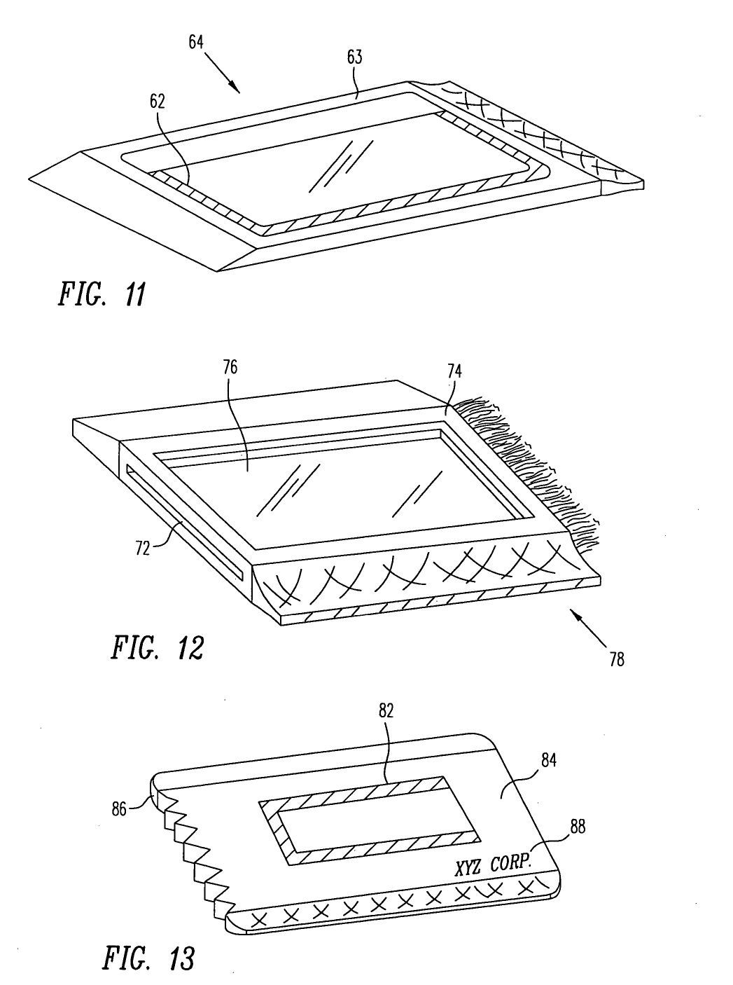

In another variation, a pocket (e.g., pouch, envelope, grove, opening, or gap, etc.) may be provide on or within the card device for receiving a typical paper business card or other paper or plastic sheets/cards. For example, the pocket may be configured to receive a typical US sized business card. In another example, the pocket is sized to receive an Asia sized business card. FIG. 11 illustrates one variation of a novelty business card where a clear plastic pouch 62 is attached to the top surface 63 of the card device 64. The clear plastic pouch 62 is sized to receive a typical paper-based business card. The user may insert his business card into the pouch 62 to personalize or customize the card device 64.

In another variation, the body of the card device may be constructed of a metallic material. A magnetic business card with user's business information may be placed over the card device and attaches to the card device through the magnetic force. In another variation, the thin sheet of magnetic material is glue to the back surface of the card device and a pocket is glue to the front surface of the card device. The user may place the card device on a metallic surface and allow the magnetic force from the magnetic sheet to hold the card device on the metallic surface. In another example, magnetic material is inserted inside the card device having a business card pocket. The user may place the business card inside the pocket to customize the card device. The card device with the business card may then be place on a metallic surface, such as a refrigerator door or on a metal cabinet.

In another variation, shown in FIG. 12, a slot 72 is provided in the body 74 of the card device 78 to receive a sheet of paper or a card, such as a business card. A window or opening 76 is provided on the top surface of the device so that when the business card is inserted inside the card device 78 one may view the information printed on the inserted business card. The window 76 may be a simple opening or it may be covered with a transparent plastic or other clear or semi-clear polymeric sheets.

In yet another variation, a slip 82 is provide on the surface 84 of the card device 86 for receiving a strip of paper or plastic, or other sheets of materials, as shown in FIG. 13. Textual or graphical information may be placed on the strip of paper or plastic before it is inserted into the slip 82 on the card device 86. For example the user may place his name and/or phone number on a strip of paper and then insert it into the slip 82 on the card device to customize the card device 86. Optionally, characters, numbers or logos 88 may be printed on the surface 84 of the card device 86. For example, a company may print its company information and logo on the card device. Each employee may customize the card device by inserting a sheet of paper or a card into the pocket that is provided on or within the card device to customize the card device. In one variation, a pocket is provide on the front face of the card device for receiving an employee's paper business card, and the back surface of the card device is printed with the company's name, logo and Internet address.

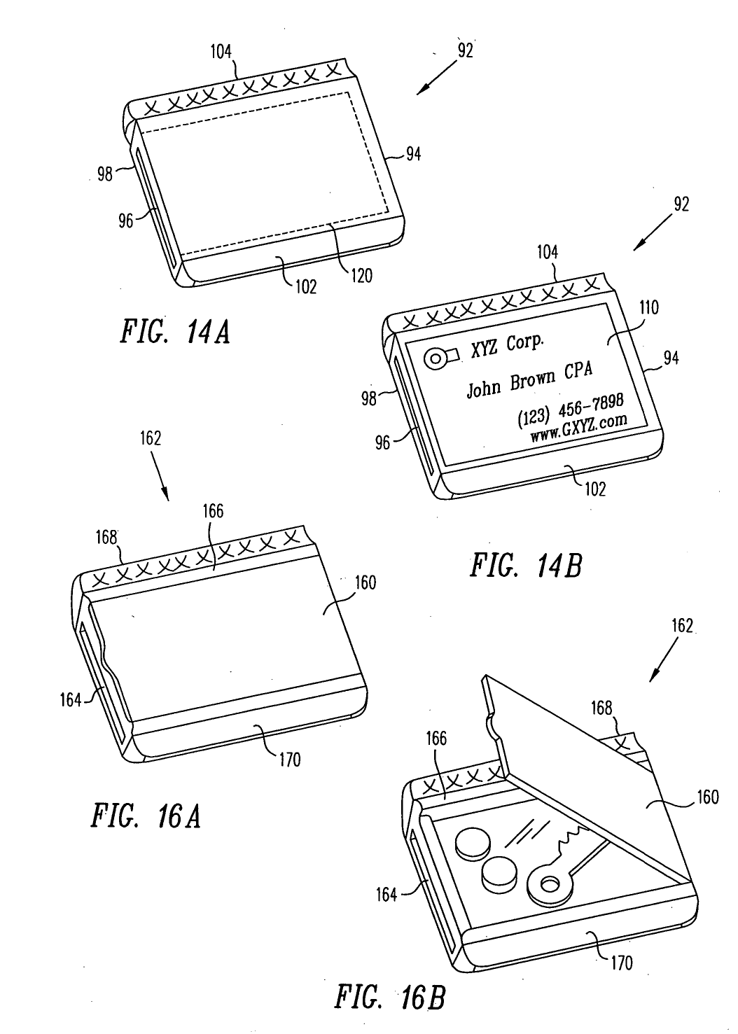

FIG. 14A illustrates yet anther variation where the novelty business card comprises a transparent body 94 configured for receiving a business card. As seen in FIG. 14A, an opening 96 is provided on the left edge 98 of the card body 94, where a user may insert a standard business card into the body of the device. Once the business card 110 is inside the device 92, an individual may view the information on the business card through the transparent card body 94, as shown in FIG. 14B. In this variation, the lower edge 102 of the card body is molded into a scraping edge, and a squeegee is attached to the upper edge 104 of the device 92. The body 94 of the card device may be constructed of various transparent or semi-transparent polymeric materials that are well known to one of ordinary skill in the art. The body of the card device may also be constructed such that only the part of the device where the face of the business card needs to show through is transparent. The opening for sliding a business card into the body of the card device may be positioned at various locations on the card body as one of ordinary skill in the art would appreciate.

Although in this variation, the slot 120 is sized to receive a business card, one of ordinary skill in the art would appreciate that card devices of various slot sizes may be implemented to fit paper or plastic cards of different sizes depending on design needs. In addition, one may construct a card device with relatively small scraping or squeegee edge, such that the over all size of the card device with an integrated business card pocket is only slightly larger than the size of a standard business card. For example, in one variation, the top surface of the card device is no more than 150% of the top surface of a typical U.S. business card. In another variation, the top surface of the card device is no more then 120% of a typical U.S. business card. In yet anther variation, the top surface of the card device extends no more then 10% beyond the top surface of a typical U.S. business card.

Alternatively, the card device with a business card pocket may be configured with only one squeegee and without a scraping edge. In another variation, the card device with a business card pocket may be configured with two or more squeegee edges.

In another variation, the card device comprises a compartment for storing small objects (e.g., pills, candies, breath mints, cosmetic brushes, etc.). This variation may be configured with one or more of the squeegees, brushes and/or scraping edges described earlier. The compartment may have a sliding cover or a flip-top cover for accessing and storing materials in the card device. Other covers or opening mechanisms that are well known to one of ordinary skill in the art may also be implemented to provide covering for the compartment. Names, logs or other identification information may be printed directly on the card device. FIG. 15A illustrates one example of a card device 130 having a compartment 132 for storage. The card body 134 has a small compartment 132 for storing pills or other small objects, and a sliding lid 136 is provided for accessing the object inside the compartment 132. When the lid 136 is slid to the closed position, the objects inside the compartment 132 are secured inside of the compartment. In this variation, the card body 134 has a squeegee edge 138 attached to bottom edge 140, a brush 142 attached to the distal end 144, a scraping surface/edge 146 extends from the top edge 148, and the lid 136 is allow to slide out from the proximal end 150 to provide user-access to the built-in compartment 132. The card body 134 and/or the covering 136 may comprise of transparent, semi-transparent, or opaque materials. In one variation the card body 134 comprises of semi transparent plastic material such that the user can see the content inside the card body 134. For example, the card body 134 and/or the lid 136 may comprise of blue, red, or yellow semitransparent hard polymeric materials. Optionally, logo, name or other information may be provided on the top cover 152 and/or on the bottom side 154 of the card device. FIG. 15B show an example where a name 156 and a logo 158 are printed on the bottom side 154 of the card device 130.

Alternatively, a separate slot or compartment may be provided to receive a business card or note card/sheet. The slot may be configured to receive a US sized business card, or it may be configured to receive an Asian sized business card. One may also configure the slot to receive both US sized and Asian sized business card. A window or opening may be provided to allow the face of the business card to show through.

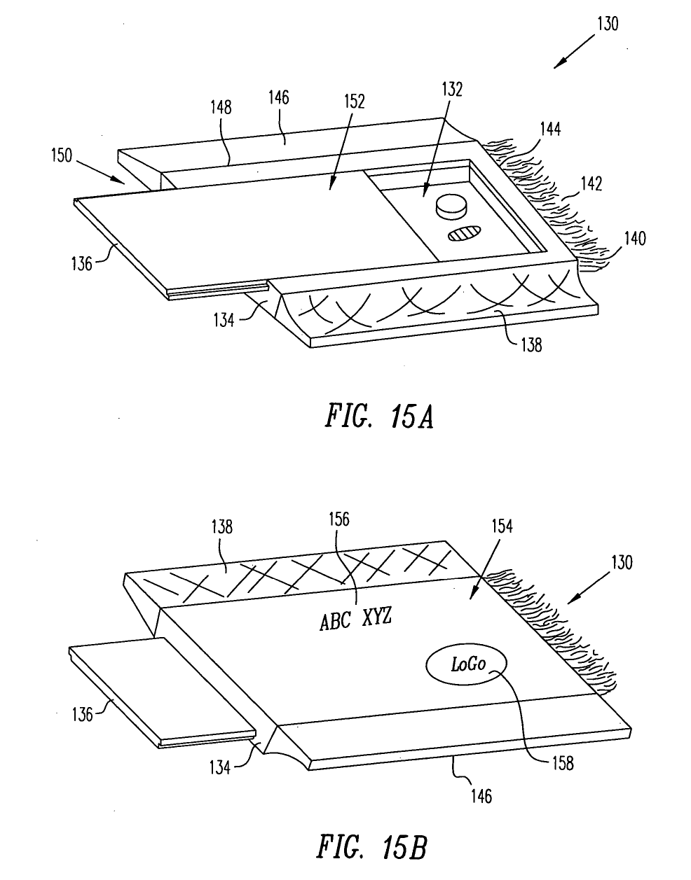

In one example, the card device comprises a flip-top for accessing the built-in compartment in the card device, as shown in FIG. 16A. In this example the flip-top 160 is provided on the top surface of the card device 162. A slot 164 may be provided for inserting a business card. The body 166 of the card device may be transparent or semi-transparent such that a business placed inside the slot may be visible through the card device body. Alternative, the body 166 may be opaque and a transparent or semitransparent window or opening may be provided so the face of the business card may be viewed by the user when the business card is inserted inside the body of the device. The device may be provided with one or more squeegee edge. Optionally, one or more of the scraping surface/edge may also be provided. In this example, the device 162 is shown with a squeegee 168 on the top edge and a hard scraping surface 170 on the bottom edge. In addition, information such as company name or logo may also be provided on one or more of the surfaces on the card device 162. For example, company logo, company information or other icons may be printed on the outer surface of the flip-top. FIG. 16B shows the flip-top card device with its flip-top 160 in the opened position to provide user access to the built-in compartment. When a business card is inserted into the slot 164, the face of the business card will be visible through the bottom side of the card device.

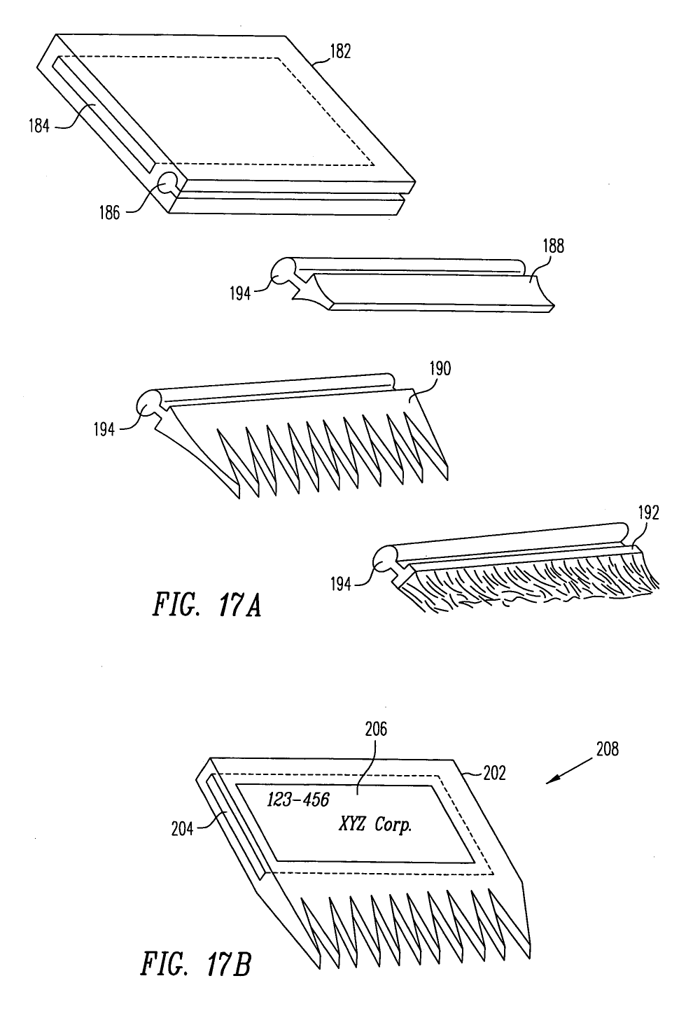

In another variation, the device comprised of a card body 182 with a slit or pocket 184 for receiving a business card, and a slot or an attachment mechanism 186 for receiving an accessory, as shown in FIG. 17A. The accessory may be a squeegee 188, a comb 190, a brush 192 or other utility attachments. The accessory may have a corresponding attachment mechanism 194 such that the accessory may be secured onto the card body through the attachment mechanism 186 on the card body 182. For example, protrusions on the accessory may fit into a slot on the card body such that the accessory may be slid onto the card body. Other mechanical or interlocking mechanisms that are well known to one of ordinary skill in the art may also be implemented on the card body and its corresponding accessory such that the accessory may be attached onto the card body. The card body may have a window or an opening such that when the business card is inserted inside the card body the user may see the information printed on the business card. Alternatively, the card body comprises a transparent or semi-transparent material such that the user may see the information printed on the business card that is inserted inside the card body. Although the card body in variation shown in FIG. 17A has a rectangular shape, in light of the disclosure herein, one of ordinary skill in the art would appreciate that the card body may be configured with other shapes (e.g., a square, a hexagon, an octagon, a circular disk, shape of a leave, shape of a dog, shape of a corporate icon or symbol, etc.).

In another variation, the accessory attachment mechanism is configured in such a way that the user may interchange between different accessories and attached the desired accessory onto the card body depending on the particular application. In a design variation, the card body may have two or more slots for receiving a plurality of accessories. For example, the front edge of the card body may have a slot for receiving a squeegee, while the rear edge may have a slot for receiving a brush.

In another variation, the device comprises a card body having a pocket for receiving a business card, and one of the edges of the card body is configured as a comb. As shown in FIG. 17B, the card body 202 has a packet 204 for receiving a business card 206. A business card 206 is inserted inside the body 202 of the card device. The lower edge 208 of the card device is molded into a comb. The card body 202 is transparent such that the user may see the information printed on the business card 206 when the business card is inserted inside the card body. A squeegee and/or a brush may also be attached onto the other edges on the card device with a comb edge.

All publications and patent applications cited in this specification are herein incorporated by reference in their entirety as if each individual publication or patent application were specifically and individually put forth herein.

This invention has been described and specific examples of the invention have been portrayed. While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above.

Therefore, to the extent there are variations of the invention, which are within the spirit of the disclosure or equivalent to the inventions found in the claims, it is my intent that this patent will cover those variations as well.

1. A device comprising:
a rectangular plate, wherein said rectangular plate is configured with a pocket for holding a card;
a squeegee attached to an edge of said rectangular plate.

2. The device of claim 1 wherein a second edge of said rectangular plate is adapted for scraping.

3. The device of claim 1 wherein said pocket is sized to receive a business card.

4. The device of claim 1 wherein said plate comprises plastic.

5. The device of claim 2 wherein said second edge is beveled.

6. The device of claim 2 wherein said second edge is serrated.

7. The device of claim 6 wherein a third edge of said plate is beveled.

8. The device of claim 1 wherein said device has a length that is less than 4 inches and a width that is less than 4 inches.

9. The device of claim 8 wherein said plate has a second edge configured for scraping.

10. The device of claim 9 wherein said pocket is configured to receive a business card.

11. The device of claim 1 wherein said device is configured with a width of 5 inches or less, a length of 4 inches or less, and a thickness of 0.5 inches or less.

12. The device of claim 3 wherein said device is configured with a width of 3.75 inches or less, a length of 2.5 inches or less, and a thickness of 0.25 inches or less.

13. The device of claim 1 wherein said pocket is configured to receive a card having a width of about 3.5 inches and a length of about 2 inches.

14. The device of claim 1 wherein said pocket is configured to receive a card having a width of about 9 centimeters and a length of about 5.4 centimeters.

15. The device of claim 1 wherein said rectangular plate comprises a transparent material.

16. The device of claim 12 wherein said rectangular plate comprise a transparent polymeric material.

17. The device of claim 11 wherein a second edge of said plate is configured for scraping.

18. The device of claim 1 further comprising:
a brush attached to a second edge on said plate.

19. The device of claim 18 wherein a third edge of said plate is configured for scraping.

20. The device of claim 19 wherein a third edge of said plate is beveled.

21. The device of claim 20 wherein said device is configured to be about the size of a standard business card.

22. A compact device for clearing fluids or debris comprising:
a plastic plate, wherein said plastic plate comprises a first edge adapted to provide squeegee action, and said plastic plate is further configured with a slot for receiving a business card.

23. The compact device of claim 22 wherein said plastic plate is further configured with a second edge adapted for scraping.

24. The compact device of claim 22 wherein said plastic plate further comprises a logo, or a mark on a surface on said device for communicating an advertising message.

25. The compact device of claim 22 wherein said plastic plate comprises a transparent material.

26. The compact device of claim 22 wherein said plastic plate is configured to be about the size of a standard business card.

27. A squeegee card comprising:
a business card shaped body wherein said body is configured with a pocket to receive a business card; and
a squeegee attached to said body.

28. The squeegee card of claim 27 further comprising:
a scarping surface attached to said business card body.

29. The squeegee card of claim 27 wherein said business card shaped body further comprises an edge configured for scraping.

30. The squeegee card of claim 27 further comprising:
a brush attached said business card shaped body.

31. The squeegee card of claim 27 wherein said business card shaped body comprises a polymeric material that is transparent.

32. Method of fabricating a squeegee device comprising the steps of:
forming a polymeric plate, wherein said polymeric plate comprises a first edge for receiving a squeegee, and a pocket for receiving a business card; and
attaching a squeegee onto said first edge.

33. The method of claim 32 further comprising the step of:
printing an advertising indicia on a surface on said polymeric plate.

34. The method of claim 32 wherein the forming step further comprises molding a second edge into a scarping surface.

35. The method of claim 32 further comprising the step of:
connecting a brush to said polymeric plate, wherein said connecting step may take place before or after the attaching step.

36. The method of claim 32 wherein said polymeric plate is about the size of a standard business card.

37. The device of claim 1 wherein said rectangular plate is further configured with a compartment for storing objected.

38. The device of claim 37 further comprising:
a cover interconnected to said rectangular plate for securing objects inside of said compartment.

39. The squeegee card of claim 27 wherein said business card shaped body is further configured with a compartment for storing objects.

40. The squeegee card of claim 39 further comprising:
a cover interconnected to said business card shaped body for securing objects inside of said compartment.

41. The squeegee card of claim 40 wherein said interconnected cover is inserted into the business card shaped body in a sliding manner.

42. A squeegee container device comprising:
a container for storing objects; and
a squeegee attached to said container.

43. The squeegee container device of claim 42 wherein said container has a card shaped configuration.

44. The squeegee card of claim 43 further comprising:
a scraping surface attached to said business card body.

45. The squeegee card of claim 42 wherein said business card shaped body comprises a polymeric material that is transparent.

46. The squeegee card of claim 44 further comprising:
a cover interconnected to said business card shaped body for securing objects inside said container.

47. A novelty business card comprising:
a card shaped body having a slot for receiving a business card, wherein when said business card inserted inside said card body at least one side of said business card is visible from an exterior of said card body, and wherein said card shaped body further comprises an attachment mechanism for receiving an accessory.

48. The novelty business card of claim 47 further comprising:
the accessory, wherein said accessory is configured with a corresponding attachment mechanism for attaching the accessory onto said card shaped body through said attachment mechanism on said card shaped body.

49. The novelty business card of claim 48 wherein said accessory comprises a squeegee.

50. The novelty business card of claim 48 wherein said accessory comprises a brush.

51. The novelty business card of claim 48 wherein said accessory comprises a comb.
